(19) United States
(12) Patent Application Publication
(10) Pub. No.: US 2013/0174068 A1
(43) Pub. Date: Jul. 4, 2013

(54) PREFERENCE MANAGEMENT FOR APPLICATION CONTROLS

(71) Applicants: Howard B. Bernstein, Lexington, MA (US); Mark D. Karuzis, Shirley, MA (US)

(72) Inventors: Howard B. Bernstein, Lexington, MA (US); Mark D. Karuzis, Shirley, MA (US)

(73) Assignee: INTERNATIONAL BUSINESS MACHINES CORPORATION, Armonk, NY (US)

(21) Appl. No.: 13/341,258

(22) Filed: Dec. 30, 2011

(51) Int. Cl. G06F 3/048

(52) U.S. Cl. 715/765

(57) ABSTRACT

A preference management system, including: a graphical user interface (GUI) displayed on a display device; a GUI control corresponding to an application within the GUI, wherein the GUI control includes a preference that defines an aspect of the application; and a graphical affordance for the preference, wherein the graphical affordance is configured to execute an operation to set a default value of the corresponding preference to a current value of the preference in response to a user input, wherein the graphical affordance is configured to set the default value for the corresponding preference independently from other preferences in the GUI control, wherein the default value is stored in a memory device.

### BACKGROUND

In a graphical user interface application, users are often allowed to specify default behavior or default control values. These are typically specified in a dialog or a set of dialogs found in the application menus and selecting a menu listing titled “Preferences” and/or “Options”. The preferences dialog may allow the users to modify the default behavior or control values for various aspects of the application.

While a user is in the context where a particular option or preference is used, the user is typically unable to access the associated preference dialog/page directly. Consequently, the user accesses the preference dialog/page by opening the preferences dialog and manually navigating to the corresponding page in order to make changes to the default behavior of a given application aspect.

### SUMMARY

Embodiments of a system are described. In one embodiment, the system is a preference management system. The system includes: a graphical user interface (GUI) displayed on a display device; a GUI control corresponding to an application within the GUI, wherein the GUI control includes a preference that defines an aspect of the application; and a graphical affordance for the preference, wherein the graphical affordance is configured to execute an operation to set a default value of the corresponding preference to a current value of the preference in response to a user input, wherein the graphical affordance is configured to set the default value for the corresponding preference independently from other preferences in the GUI control, wherein the default value is stored in a memory device. Other embodiments of a method and a computer program product are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a preference management system.

FIG. 2 depicts a schematic diagram of one embodiment of the application of FIG. 1.

FIG. 3 depicts a schematic diagram of one embodiment of the application of FIG. 1.

FIG. 4 depicts a schematic diagram of one embodiment of the application of FIG. 1.

FIG. 5 depicts a flowchart diagram of one embodiment of a method for managing preferences for application controls.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for managing preferences for application controls. Specifically, the system provides a graphical affordance that allows a user to access or modify default values for preferences that correspond to controls in an application. In some embodiments, the graphical affordance allows a user to open a dropdown menu to perform one of several operations corresponding to the preferences for a given control. The system and method described herein may provide education for the user regarding the preference options available to the user for a given application, as well as offer convenient solutions to the user for modifying or setting preference options.

Some conventional systems provide a “Set As Defaults” or similar functionality—typically applying to all controls present in a particular dialog, application or other interface—to set the current settings or values of the controls as the default values for any subsequent uses of that interface. While this solution may allow the user to modify default values for preferences without entering a separate preferences dialog or page, this has several drawbacks: 1) it replaces all of the default values for each preference in the interface with the current values, i.e., there is no ability to pick and choose which preferences to replace individually; 2) there is no indication about whether or not a particular field's default value is currently a preference; and 3) for current default preference values, there is no way to know what other possible preference values are. Consequently, a system that allows users to view current default values for control preferences, modify those default values on an individualized basis, and/or view possible preference values for each control offers simple and efficient customizability.

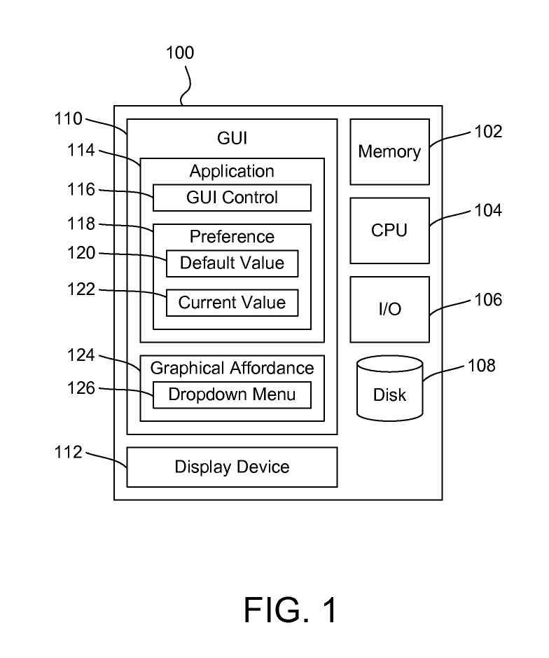

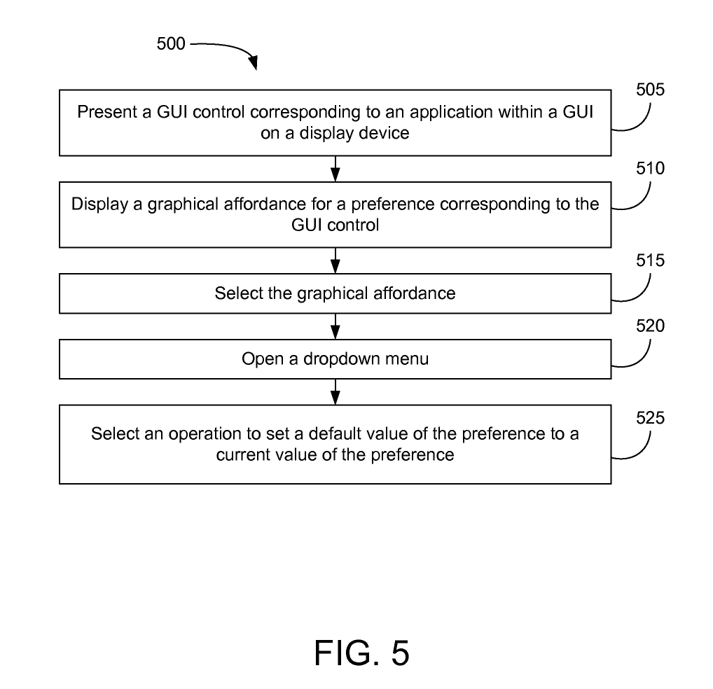

FIG. 1 depicts a schematic diagram of one embodiment of a preference management system. The depicted preference management system 100 includes various components, described in more detail below, that are capable of performing the functions and operations described herein. In one embodiment, at least some of the components of the mapping system 100 are implemented in a computer system. For example, the functionality of one or more components of the preference management system 100 may be implemented by computer program instructions stored on a computer memory device 102 and executed by a processing device 104 such as a CPU. The preference management system 100 may include other components, such as a disk storage drive 108, input/output devices 106, a graphical user interface (GUI) 110, and a display device 112. Some or all of the components of the preference management system 100 may be stored on a single computing device or on a network of computing devices, including a wireless communication network. The preference management system 100 may include more or fewer components or subsystems than those depicted herein. In some embodiments, the preference management system 100 may be used to implement the methods described herein as depicted in FIG. 5.

In various embodiments, the display device 112 may be a computer monitor, a touch screen, or any other display device. The GUI 110 is an interactive interface displayed on the display device 112. In one embodiment, the GUI 110 presents an application 114 on the display device 112 to allow a user to perform various operations associated with the application 114. The application 114 may include various GUI controls 116 that allow the user to customize operations within the application 114 by storing a preference 118 corresponding to a given control on a memory device. The preference 118 may include a default value 120 that determines how the application 114 operates for the corresponding GUI control 116. In some embodiments, the default value 120 may be modified to alter the behavior of the GUI control 116. In one embodiment, the user modifies the behavior of the GUI control 116 by setting the default value 120 to the current value 122 selected in the application 114. In some embodiments, the GUI 110 may present an operating system capable of performing various operations without additional applications 114.

In some embodiments, the preference management system 100 may be implemented as part of a standalone application 114. In other embodiments, the preference management system 100 may be implemented as part of an operating system, such that the user may use the preference management system 100 in the operating system or in multiple applications 114 within the operating system.

In one embodiment, the GUI 110 displays a graphical affordance 124 that allows the user to perform various operations related to the preferences 118 for a given GUI control 116 in response to a user input, such as clicking on the affordance 124. The affordance 124 may open a dropdown menu 126 in response to the user input. The dropdown menu 126 may include several operations for modifying or otherwise interacting with the preferences 118 for the GUI control 116. In one embodiment, performing an action such as hovering the cursor over the affordance 124 displays the current default preference value 120 for the GUI control 116, which may allow the user to easily view the default value 120 without opening a separate preferences dialog/page. In other embodiments, the default value 120 may be displayed in response to other user actions.

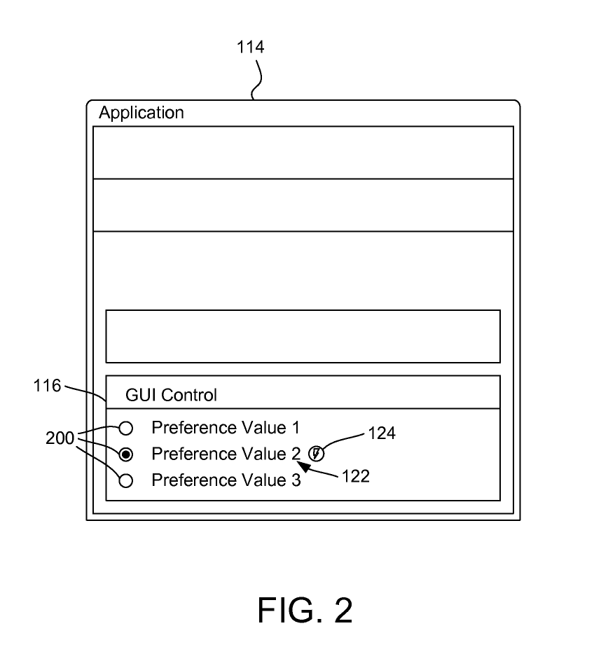

FIG. 2 depicts a schematic diagram of one embodiment of the application 114 of FIG. 1. While the preference management system 100 is described herein in conjunction with the application 114 of FIG. 2, the preference management system 100 may be used in conjunction with any application 114.

In one embodiment, the application 114 is displayed in a dialog window. In some embodiments, the application 114 may include multiple dialog windows. Each dialog window may include one or more GUI controls 116 for performing various operations within the application 114. A GUI control 116 may include one or more preference values that determine how the application 114 operates. In some embodiments, the preference values may modify a single operation setting in the application 114. Selecting different preference values may cause the application 114 to perform in different ways with respect to a given function or operation.

In one embodiment, the user is able to select a current preference value 122 for the GUI control 116 by selecting a radio button 200 from a group of radio buttons 200 with corresponding options. Selecting the radio button 200 may set a current preference value 122 for the GUI control 116 temporarily, such that the preference value applies only to a current instance of the application 114, dialog, or interface. Subsequent instances of the application 114 may then use the default preference value 120. This may allow the user to temporarily modify the behavior of the application 114, while resetting the GUI control 116 to the default value 120 in subsequent instances of the application 114 to determine the behavior of the application 114 for those instances.

In one embodiment, the preference management system 100 displays a graphical affordance 124, such as a glyph or tool tip icon, proximate the GUI control 116. The affordance 124 may indicate to the user that the GUI control 116 includes a preference value located in a preferences dialog. In one embodiment, the graphical affordance 124 is displayed proximate a current preference value 122 that is selected. The current preference value 122 may be selected, for example, when the user clicks on the radio button 200 for the desired preference value. The graphical affordance 124 is then displayed in the GUI 110 proximate the selected preference value. The affordance 124 may be displayed on any side of the preference value, based on the presentation layout of the GUI 110, the convenience of the user, or for other reasons. In one embodiment, the graphical affordance 124 is displayed only in response to the user selecting a preference value. In another embodiment, the graphical affordance 124 is displayed proximate a preference value on which the cursor is hovering. In other embodiments, the graphical affordance 124 may be displayed in affordance with other or additional rules.

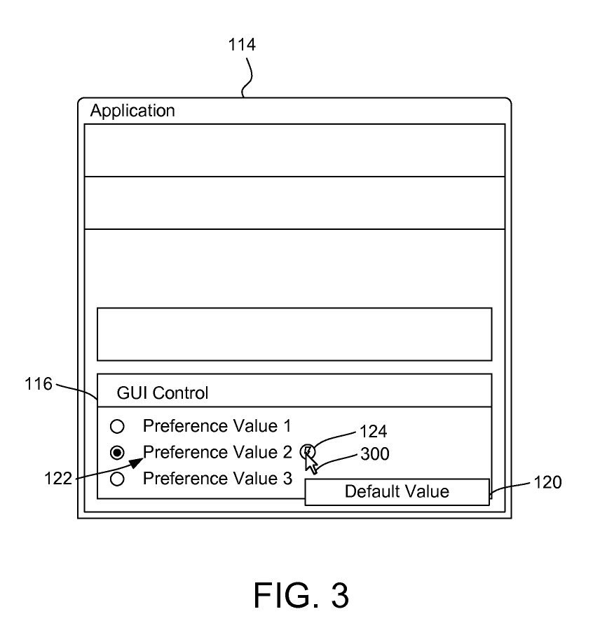

FIG. 3 depicts a schematic diagram of one embodiment of the application 114 of FIG. 1. While the preference management system 100 is described herein in conjunction with the application 114 of FIG. 3, the preference management system 100 may be used in conjunction with any application 114.

In one embodiment, the preference management is configured to display the default value 120 from the preferences dialog in the GUI 110 in response to a user input. In one embodiment, the preference management system 100 displays the default value 120 in response to the user hovering the cursor 300 over the graphical affordance 124. In other embodiments, the default value 120 may be displayed in response to other user actions. The default value 120 may be displayed in a pop-up element proximate the cursor location or other location near the graphical affordance 124 to allow the user to easily view the default value 120 associated with the GUI control 116. The default value 120 may alternatively be displayed at a predetermined location within the application 114, such as a status bar. By displaying the default value 120 in such a manner, the preference management system 100 may allow the user to view the default value 120 for any GUI control 116 without opening a separate preference dialog.

Once the user knows the default value 120 for the GUI control 116, the user may make a make a determination to change the default value 120 to the current value 122 if the current value 122 is different than the default value 120, or to leave the default value 120 as stored in the preference dialog. In one embodiment, the user sets the default value 120 to the current value 122 by performing a user action, such as by clicking on the graphical affordance 124.

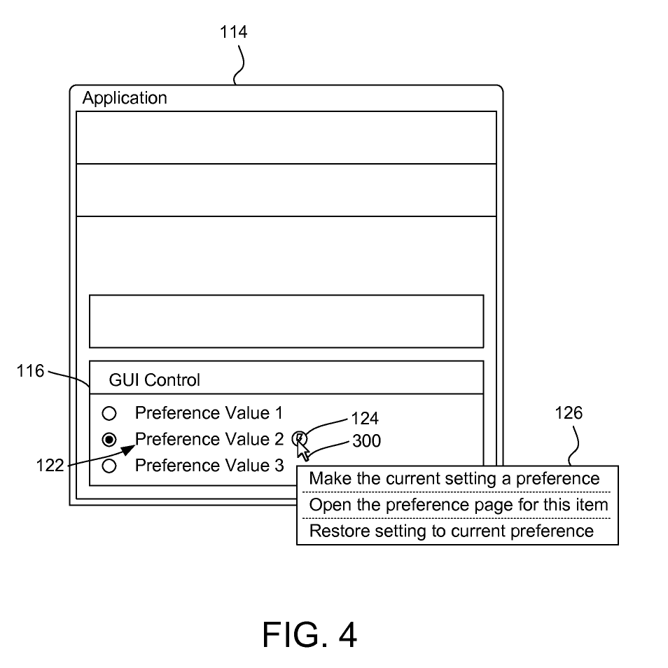

FIG. 4 depicts a schematic diagram of one embodiment of the application 114 of FIG. 1. While the preference management system 100 is described herein in conjunction with the application 114 of FIG. 4, the preference management system 100 may be used in conjunction with any application 114.

In one embodiment, the preference management system 100 is configured to display a dropdown menu 126 in response to a user action. The user action may include clicking the graphical affordance 124, double-clicking the graphical affordance 124, hovering over the graphical affordance 124 with the cursor 300 for a predetermined period of time, or any other user action.

The dropdown menu 126 may include operations related to the preferences 118 for the GUI control 116. In one embodiment, the dropdown menu 126 includes an operation to make the current setting a preference 118. This operation may replace the default value 120 for the GUI control 116 with the current value 122 selected by the user. The current value 122 may be stored in the memory device so that the application 114 is able to retrieve the new default value 120 for subsequent instances of the application 114 or dialog. The new default value 120 may then continue to be used as the preference 118 for the GUI control 116 until replaced by another preference value or by resetting the default value 120 to a previous setting.

In one embodiment, the dropdown menu 126 includes an option to open the preferences dialog for the application 114. This operation may open the general preference page that may otherwise be found in a menu or listing within the application 114. The preferences dialog may include preference settings that determine the behavior of the application 114 as a whole, including individual GUI controls 116 within the application 114. Selecting this option may also open the preference dialog directly to the preference page containing the preferences 118 for the GUI control 116 corresponding to the graphical affordance 124. This provides a shortcut for the user to easily find the applicable preference page in the preferences dialog and to limit the need for the user to search through the preference dialog to find the correct location of the corresponding preference 118.

In one embodiment, the dropdown menu 126 includes an option to restore the setting to the current preference 118, which sets the current value 122 to the default value 120 saved in the preferences dialog. This may provide a simple way for the user to restore the settings for a single GUI control 116 without restoring the settings for all GUI controls 116 in a given dialog or application 114. In some embodiments, the dropdown menu 126 includes more operations than those described herein, including further operations for modifying the default or current preference settings for the GUI control 116.

In one example of the system 100 implemented in a GUI 110, the application 114 includes a checkout dialog that allows the user to check out materials from an online library. The checkout dialog may require information from the user to complete the transaction, display information regarding the transaction to the user, or perform various other operations for the checkout process. The dialog may also include a GUI control 116 that allows the user to define a behavior of the checkout dialog or application 114 for the transaction by selecting a current preference value 122 displayed in the GUI control 116, such as opting to prefer a reserved checkout over an unreserved checkout.

When the user selects the current value 122, a graphical affordance 124 may be displayed next to the selected current value 122. The user may then view the default value 120 associated with the GUI control 116 and opt to replace the default value 120 with the current value 122, such that the application 114 behaves according to the selected current value 122 for each subsequent materials checkout. While the preference management system 100 is described in conjunction with a checkout dialog for an online library, the preference management system 100 may be used with any application.

FIG. 5 depicts a flowchart diagram of one embodiment of a method 500 for managing preferences 118 for application controls. Although the method 500 is described in conjunction with the preference management system 100 of FIG. 1, embodiments of the method 500 may be implemented with other types of preference management systems 100.

In one embodiment, the preference management system 100 displays the GUI 110 on the display device 112. The system 100 presents 505 the GUI control 116 corresponding to the given application 114 within the GUI 110 so that the GUI control 116 is viewable to the user. The GUI 110 may be an interactive interface that allows the user to perform operations within the GUI 110. The GUI control 116 may include a plurality of preferences 118 that define the behavior of different aspects of the application 114.

The system 100 also displays 510 a graphical affordance 124 for one of the preferences 118. The graphical affordance 124 is configured to execute an operation to set a default value 120 of the corresponding preference 118 to a current value 122 of the preference 118 in response to a user input. The default value 120 of the corresponding preference 118 is set independently from other preferences 118 in the GUI control 116, such that the default values 120 for the other preferences 118 are unmodified by the graphical affordance 124 for the corresponding preference 118. In one embodiment, the user input includes selecting 515 the graphical affordance 124 by clicking on the graphical affordance 124. In one embodiment, clicking on the graphical affordance 124 opens 520 a dropdown menu 126 that includes a plurality of selectable operations in response to selecting the graphical affordance 124 with a cursor 300. The default value 120 is stored in a memory device so that the application 114 operates or behaves according to the default value 120 in subsequent instances of the application 114. The operation to set the default value 120 of the preference 118 to the current value 122 of the GUI control 116 may be included in the operations in the dropdown menu 126, such that when the user selects 525 the operation from the dropdown menu 126, the default value 120 is set to the current value 122 of the preference 118. In other embodiments, the preference management system 100 sets the default value 120 of the preference 118 to the current value 122 of the GUI control 116 in response to one or more other user actions.

In one embodiment, the preference management system 100 opens a preferences interface in response to a user selection of a corresponding operation in the dropdown menu 126. The preferences interface may be a dialog window, tab, or page within the application 114 or interface in which the user is operating. The system 100 may also automatically navigate within the preferences interface to display the preference 118 for the GUI control 116.

In one embodiment, the system 100 resets the current value 122 of the GUI control 116 to the default value 120 that is currently stored in the preferences interface in response to a user selection of a corresponding operation in the dropdown menu 126. This allows the user to reset the preference value for a single GUI control 116 without modifying the preference settings for other GUI controls 116.

In one embodiment, the system 100 displays the default value 120 of the GUI control 116 proximate a cursor position in response to a cursor hover action over the graphical affordance 124. The default value 120 may be displayed on the GUI 110 in any manner, including a pop-up box proximate the cursor position, in a status bar, or any other position within the GUI 110 so that the user is able to easily view the default value 120 currently stored in the preferences interface.

The preference management system 100 may display the graphical affordance 124 for the preference 118 according to various rules. In one embodiment, the graphical affordance 124 is displayed for the preference 118 in response to a user action such as hovering over one of the preference values in the GUI control 116 with the cursor 300. In another embodiment, the graphical affordance 124 is displayed in response to the cursor 300 entering a predetermined area of the GUI control 116. In another embodiment, the graphical affordance 124 is displayed for the preference 118 in response to a user selection of the current value 122 for the preference 118. Thus, the affordance 124 may only be displayed on the GUI 110 after the user has made a selection of one of the preference values in the GUI control 116. The graphical affordance 124 may alternatively be displayed according to other rules not described herein.

In one embodiment, the preference management system 100 displays a separate graphical affordance 124 for each preference 118 setting in the GUI control 116. Each graphical affordance 124 may be configured to execute an operation to set a default value 120 of the corresponding preference setting to a corresponding current value 122. The default value 120 for each preference 118 is set independently from the other preferences 118 in the GUI control 116 based on the corresponding graphical affordance 124. The default value 120 for each preference 118 is stored in the memory device.

An embodiment of a preference management system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for managing preferences 118 for application controls.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage medium to store a computer readable program, wherein the computer readable program, when executed by a processor within a computer, causes the computer to perform operations for managing preferences for application controls, the operations comprising:
displaying a graphical user interface (GUI) on a display device;
presenting a GUI control corresponding to an application within the GUI, wherein the GUI control comprises a plurality of preferences that define different aspects of the application; and
displaying a graphical affordance for one of the preferences, wherein the graphical affordance is configured to execute an operation to set a default value of the corresponding preference to a current value of the preference in response to a user input, wherein the graphical affordance is configured set the default value for the corresponding preference independently from other preferences in the GUI control, wherein the default value is stored in a memory device.

2. The computer program product of claim 1, wherein the computer readable program, when executed on the computer, causes the computer to perform additional operations, comprising:
opening a dropdown menu comprising a plurality of selectable operations in response to selecting the graphical affordance with a cursor, wherein the selectable operations comprise the operation to set the default value of the preference to the current value of the GUI control.

3. The computer program product of claim 2, wherein the computer readable program, when executed on the computer, causes the computer to perform additional operations, comprising:
opening a preferences interface in response to a user selection of a corresponding operation in the dropdown menu; and
automatically navigating within the preferences interface to display the preference for the GUI control.

4. The computer program product of claim 2, wherein the computer readable program, when executed on the computer, causes the computer to perform additional operations, comprising:
resetting the current value of the GUI control to the default value in response to a user selection of a corresponding operation in the dropdown menu.

5. The computer program product of claim 1, wherein the computer readable program, when executed on the computer, causes the computer to perform additional operations, comprising:
displaying the default value within the GUI in response to a cursor hover action over the graphical affordance.

6. The computer program product of claim 1, wherein displaying the graphical affordance for the preference further comprises displaying the graphical affordance in response to a user selection of the current value for the preference.

7. The computer program product of claim 1, wherein the computer readable program, when executed on the computer, causes the computer to perform additional operations, comprising:
displaying a separate graphical affordance for each preference in the GUI control, wherein each graphical affordance is configured to execute an operation to set a default value of the corresponding preference to a corresponding current value, wherein each graphical affordance is configured to set the default value of the corresponding preference independently from other preferences in the GUI control, wherein the default value for each preference is stored in the memory device.

8. A method for managing preferences for application controls, the operations comprising:
displaying a graphical user interface (GUI) on a display device;
presenting a GUI control corresponding to an application within the GUI, wherein the GUI control comprises a preference that defines an aspect of the application; and
displaying a graphical affordance for the preference, wherein the graphical affordance is configured to execute an operation to set a default value of the corresponding preference to a current value of the preference in response to a user input, wherein the graphical affordance is configured to set the default value for the corresponding preference independently from other preferences in the GUI control, wherein the default value is stored in a memory device.

9. The method of claim 8, further comprising:
opening a dropdown menu comprising a plurality of selectable operations in response to selecting the graphical affordance with a cursor, wherein the selectable operations comprise the operation to set the default value of the preference to the current value of the GUI control.

10. The method of claim 9, further comprising:
opening a preferences interface in response to a user selection of a corresponding operation in the dropdown menu; and
automatically navigating within the preferences interface to display the preference for the GUI control.

11. The method of claim 9, further comprising:
resetting the current value of the GUI control to the default value in response to a user selection of a corresponding operation in the dropdown menu.

12. The method of claim 8, further comprising:
displaying the default value within the GUI in response to a cursor hover action over the graphical affordance.

13. The method of claim 8, wherein displaying the graphical affordance for the preference further comprises displaying the graphical affordance in response to a user selection of the current value for the preference.

14. The method of claim 8, further comprising:
displaying a separate graphical affordance for each preference in the GUI control, wherein each graphical affordance is configured to execute an operation to set a default value of the corresponding preference to a corresponding current value, wherein each graphical affordance is configured to set the default value of the corresponding preference independently from other preferences in the GUI control, wherein the default value for each preference is stored in the memory device.

15. A preference management system, comprising:
a graphical user interface (GUI) displayed on a display device;
a GUI control corresponding to an application within the GUI, wherein the GUI control comprises a preference that defines an aspect of the application; and
a graphical affordance for the preference, wherein the graphical affordance is configured to execute an operation to set a default value of the corresponding preference to a current value of the preference in response to a user input, wherein the graphical affordance is configured to set the default value for the corresponding preference independently from other preferences in the GUI control, wherein the default value is stored in a memory device.

16. The system of claim 15, wherein the graphical affordance is further configured to:
open a dropdown menu comprising a plurality of selectable operations in response to selecting the graphical affordance with a cursor, wherein the selectable operations comprise the operation to set the default value of the preference to the current value of the GUI control.

17. The system of claim 16, wherein the graphical affordance is further configured to:
open a preferences interface in response to a user selection of a corresponding operation in the dropdown menu; and
automatically navigate within the preferences interface to display the preference for the GUI control.

18. The system of claim 16, wherein the graphical affordance is further configured to:
reset the current value of the GUI control to the default value in response to a user selection of a corresponding operation in the dropdown menu.

19. The system of claim 15, wherein the graphical affordance is further configured to:
display the default value within the GUI in response to a cursor hover action over the graphical affordance.

20. The system of claim 15, wherein the graphical affordance is further configured to:
display a separate graphical affordance for each preference in the GUI control, wherein each graphical affordance is configured to execute an operation to set a default value of the corresponding preference to a corresponding current value, wherein each graphical affordance is configured to set the default value of the corresponding preference independently from other preferences in the GUI control, wherein the default value for each preference is stored in the memory device.
